(19) United States
(12) Patent Application Publication
(10) Pub. No.: US 2010/0257201 A1
(43) Pub. Date: Oct. 7, 2010

(54) Method And System For Pulling Network Contents

(75) Inventor: Yuanqiang Chen, Shenzhen City (CN)

Correspondence Address: HARNESS, DICKEY & PIERCE, P.L.C., P.O. BOX 828, BLOOMFIELD HILLS, MI, 48303, US

(73) Assignee: TENCENT TECHNOLOGY (SHENZHEN) COMPANY LIMITED, Shenzhen City (CN)

(21) Appl. No.: 12/816,877

(22) Filed: Jun. 16, 2010

Related U.S. Application Data
(63) Continuation of application No. PCT/CN2009/071471, filed on Apr. 27, 2009.

(30) Foreign Application Priority Data
May 30, 2008 (CN) 200810098354.9

(51) Int. Cl. G06F 17/30; G06F 3/00

(52) U.S. Cl. 707/770; 710/55; 707/E17.014

(57) ABSTRACT

Embodiments of the present invention provide a method and system for pulling network contents. The method includes: recording operation information of a network user; setting at least one of network service priority and user group priority for the network user according to the operation information of the network user; generating and storing a contents pulling strategy corresponding to at least one of the network service priority and the user group priority; when it is necessary to pull network contents for the network user, obtaining the contents pulling strategy corresponding to at least one of the network service priority and the user group priority of the network user, and pulling the network contents according to the contents pulling strategy. The system includes an operation information database, a priority generator, a contents-pulling-strategy generator and a network contents pulling agent.

### CROSS-REFERENCE TO RELATED APPLICATIONS

This application is a continuation of International application No. PCT/CN2009/071471, filed on Apr. 27, 2009. This application claims the benefit and priority of Chinese Patent Application No. 200810098354.9, filed May 30, 2008. The entire disclosures of each of the above applications are incorporated herein by reference.

### FIELD

The present disclosure relates to Internet technologies, and more particularly, to a method and system for pulling network contents.

### BACKGROUND

This section provides background information related to the present disclosure which is not necessarily prior art.

When an Internet Service Provider (ISP) provides services for an Internet user, it is necessary for a client, located by the Internet user, to pull corresponding network contents from an Internet server. For example, when an Internet user opens a certain website through a browser, it is necessary for a client, located by the Internet user, to pull corresponding network contents from the website server, and to display or output the network contents to the Internet user.

Prior method for pulling network contents is as follows. A uniform network contents pulling rule is utilized to pull network contents for all the Internet users.

Problems arisen from the prior method for pulling network contents are as follows.

1. From the standpoint of Internet users, each Internet user pays attention to different network services, when a uniform pulling rule is utilized to pull network contents, the following scene may be occurred. Some Internet users may obtain network services to which he/she does not pay attention at first, instead of obtaining network services to which he/she pays much attention. Thus, user experience is lower.

2. From the standpoint of the ISP, since it is necessary to provide services for a large number of Internet users, when all the Internet users pull network contents with the same pulling rule, personal services cannot be provided for network users, and thus user experience may be affected.

### SUMMARY

This section provides a general summary of the disclosure, and is not a comprehensive disclosure of its full scope or all of its features.

In view of above, objectives of embodiments in the present invention are to provide a method and system for pulling network contents, so as to provide different network-contents pulling services for different network users, and to improve user experience.

To achieve the above objectives, technical solution provided by embodiments of the present invention is as follows.

A method for pulling network contents, including:
recording operation information of a network user;
setting at least one of network service priority and user group priority for the network user according to the operation information of the network user;
generating and storing a contents pulling strategy corresponding to at least one of the network service priority and the user group priority;
when it is necessary to pull network contents for the network user, obtaining the contents pulling strategy corresponding to at least one of the network service priority and the user group priority of the network user, and
pulling the network contents according to the contents pulling strategy.

A system for pulling network contents, in which the system includes an operation information database, a priority generator, a contents-pulling-strategy generator and a network contents pulling agent,
the operation information database is configured to record operation information of a network user;
the priority generator is configured to set at least one of network service priority and user group priority for the network user according to the operation information in the operation information database;
the contents-pulling-strategy generator is configured to generate and store a contents pulling strategy corresponding to at least one of the network service priority and the user group priority in the priority generator;
the network contents pulling agent is configured to obtain the contents pulling strategy corresponding to at least one of the network service priority and the user group priority of the network user, when it is necessary to pull network contents for the network user, and pull the network contents according to the contents pulling strategy.

It can be seen that in the embodiments of the present invention, the network service priority and/or user group priority of a network user may be set according to operation information of the network user, a contents pulling strategy corresponding to the priority may be generated, and network contents may be pulled for the network user according to the contents pulling strategy.

From the standpoint of the Internet users, since these contents pulling strategies are based on former operation information of the network user, degree of attention paid by the network user to each kind of network services may be demonstrated. Thus, when adopting different contents pulling strategies for different network users, a network user may be enabled to obtain cared network services at first, and user experience may be improved.

From the standpoint of the ISP, when providing services for a large number of Internet users, since contents pulling strategies of different Internet users are generally different, personal services may be provided for network users, and user experience may be improved.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a flowchart illustrating a method for pulling network contents.

FIG. 2 is a flowchart illustrating a method for pulling network contents in accordance with a method embodiment of the present invention.

FIG. 3 is a diagram illustrating structure of a system for pulling network contents in accordance with a system embodiment of the present invention.

FIG. 4 is a diagram illustrating structure of a priority generator 302.

FIG. 5 is a diagram illustrating structure of a priority buffer 305.

FIG. 6 is a schematic diagram illustrating storage structure of a user group priority container 3052 and a network service priority container 3053.

FIG. 7 is a diagram illustrating structure of a contents-pulling-strategy generator 303.

FIG. 8 is a diagram illustrating structure of a contents-pulling-strategy buffer 306.

FIG. 9 is a diagram illustrating structure of a network contents pulling agent 304.

FIG. 10 is a diagram illustrating structure of a user group detecting agent 309.

Corresponding reference numerals indicate corresponding parts throughout the several views of the drawings.

### DETAILED DESCRIPTION

Example embodiments will now be described more fully with reference to the accompanying drawings.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

In the embodiments of the present invention, a priority may be set for a network user according to operation information of the network user, a contents pulling strategy may be generated according to the priority, when it is necessary to pull network contents for the network user, the network contents may be pulled according to the contents pulling strategy of the network user.

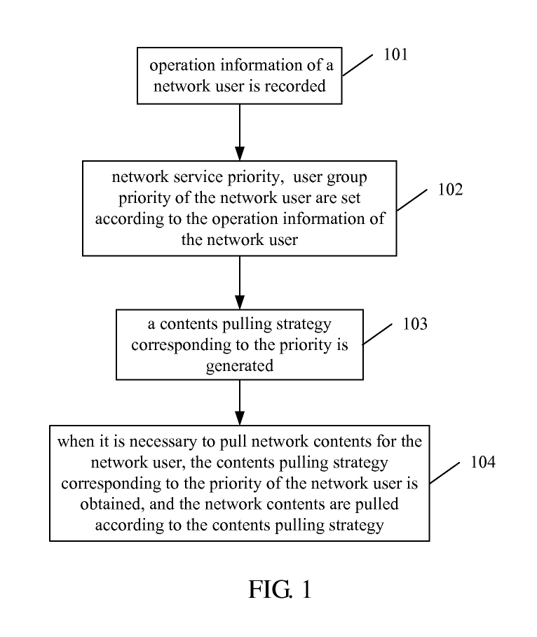

FIG. 1 is a flowchart illustrating a method for pulling network contents. As shown in FIG. 1, the method includes the following blocks.

Block 101: operation information of a network user is recorded.

Block 102: a network service priority and/or a user group priority of the network user are/is set according to the operation information of the network user.

Block 103: a contents pulling strategy corresponding to the priority may be generated and stored.

Block 104: when it is necessary to pull network contents for the network user, the contents pulling strategy corresponding to the priority of the network user may be obtained, and the network contents may be pulled according to the contents pulling strategy.

To make objectives, technical solutions and advantages of the invention more clear, detailed descriptions about the invention are further provided in the following accompanying with attached figures and embodiments.

### Method Embodiment

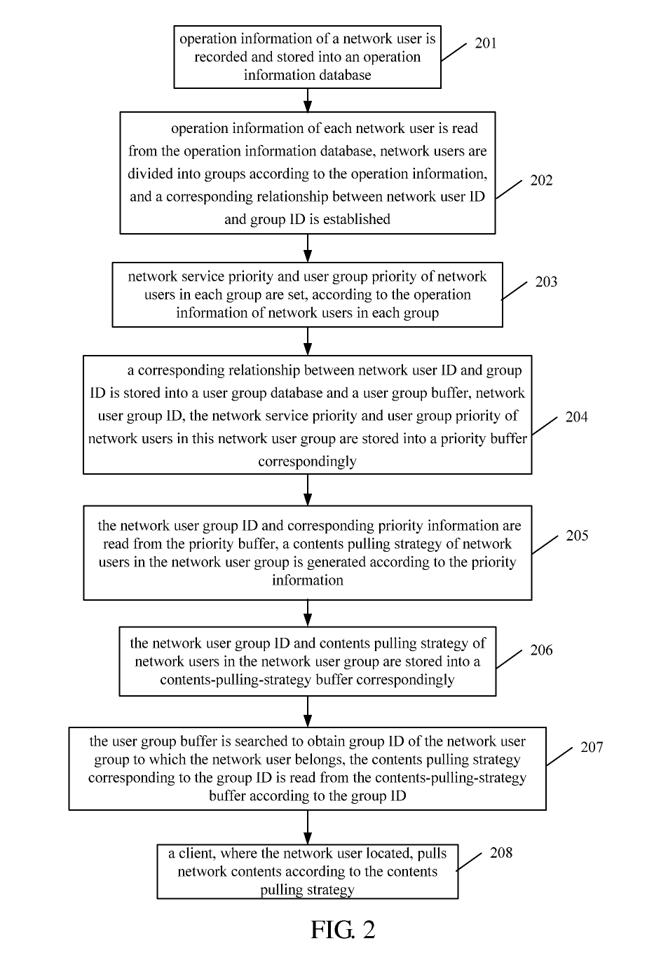

In the embodiment, network users may be divided into groups according to recorded operation information about the network users, network service priority and user group priority may be set for network users in each group, a contents pulling strategy corresponding to the priority may be generated, when it is necessary to pull network contents, the network contents may be pulled according to the contents pulling strategy corresponding to a user group where the network user is located. Detailed descriptions about the method will be provided in the following with reference to FIG. 2.

FIG. 2 is a flowchart illustrating a method for pulling network contents in accordance with a method embodiment of the present invention. As shown in FIG. 2, the method includes the following the blocks.

Block 201, operation information of a network user is recorded and stored into an operation information database.

In the block, the operation information of the network user and Identity (ID) of the network user are stored into the operation information database correspondingly.

Block 202, the operation information of each network user is read from the operation information database, network users are divided into groups according to the operation information, and a corresponding relationship between network user ID and group ID is established.

In the block, in order to expedite dividing network users into groups, network user ID and corresponding operation information may be read from the operation information database periodically or according to reading instruction, and then may be stored into a buffer. And then, the network users may be divided into groups according to the operation information in the buffer, the corresponding relationship between the network user ID and group ID may be established. In the block, the network user ID and corresponding operation information may be directly read from the operation information database, the network users may be divided into groups, the corresponding relationship between the network user ID and group ID may be established. One network user may belong to one network user group, or belong to at least two network user groups.

Block 203, network service priority and user group priority may be set for users in each group, according to the operation information of users in each group.

The operation information of a user may reflect degree of attention paid by the user to each kind of network service, e.g., a network service with much concern of a user may be frequently used, and duration thereof may also be longer. A higher priority may be set for a network service with much concern according to the operation information.

The operation information of a user may also reflect difference of user type, e.g., service payment operation of a user demonstrates that the user is a payment user instead of a free user, and a higher priority may be set for the payment user according to the operation information.

Block 204, a corresponding relationship between network user ID and group ID may be stored into a user group database and a user group buffer. Network user group ID, the network service priority and user group priority of network users in this network user group are stored into a priority buffer correspondingly.

In the block, after storing the corresponding relationship between the network user ID and group ID into the user group database, it is necessary to further store the corresponding relationship into the user group buffer, so as to expedite searching for a network user group to which a network user belongs. Before correspondingly storing the network user group ID, the network service priority and user group priority of network users in this network user group, a corresponding relationship between the network user group ID and the network service priority, user group priority of network users in the network user group may be stored into the priority database at first, so as to store the corresponding relationship for a long time.

In the block, the user group priority and network service priority of network users in a network user group may be stored corresponding to the network user group ID. Thus, the user group priority and network service priority of network users in the network user group may be searched out through the group ID. Also, user group type and user group priority of network users in a network user group may be stored corresponding to the network user group ID. Thus, the user group type and user group priority of network users in a network user group may be searched out through the group ID. Still also, network service type and network service priority of network users in a network user group may be stored corresponding to the network user group ID. Thus, the network service type and network service priority of network users in the network user group may be searched out through the group ID.

In the block, the corresponding relationship between the network user ID and network user group ID may also be stored in the priority buffer, so as to search out a network user group to which a certain network user belongs.

Block 205, the network user group ID and corresponding priority information may be read from the priority buffer, contents pulling strategy of network users in the network user group may be generated according to the priority information.

In the contents pulling strategy, it may be specified that network contents corresponding to a network service with higher priority to be pulled at first, or it may be specified that to pull network contents for a user with higher priority at first.

Which contents pulling strategy corresponds to each priority may also be determined according to strategy of the ISP. Fox example, as to a network user with payment (user priority is higher), if the user writes logs frequently (network service of writing logs possesses a higher priority), an Internet Protocol (IP) address of a server with higher network bandwidth and abundant log resources may be designated as IP address of pulling server for the network user.

Block 206, the network user group ID and contents pulling strategy of network users in the network user group may be stored into a contents-pulling-strategy buffer correspondingly.

Before storing a corresponding relationship between the network user group ID and contents pulling strategy of network users in the network user group into the contents-pulling-strategy buffer, the corresponding relationship may also be stored into a contents-pulling-strategy database, so as to store the corresponding relationship for a long time.

Block 207, when it is necessary for a client, where a network user located, to pull network contents for the network user, the user group buffer may be searched, to obtain ID of the network user group to which the network user belongs, and the contents pulling strategy corresponding to the network user group ID may be read from the contents-pulling-strategy buffer according to the network user group ID.

Block 208, the client, where the network user located, pulls network contents according to the contents pulling strategy.

In the block, a pulling rule is firstly generated according to contents pulling strategy, and then network contents may be pulled according to the pulling rule. Network contents to be pulled, pulling sequence of various network contents and so on, may be specified in the contents pulling strategy. Specific network address, operation blocks of network contents to be pulled, and so on, may be specified in the pulling rule. The pulling rule may be generated with one pulling strategy, or may be generated with at least two constituted pulling strategies.

In the method embodiment, if priority information in the priority buffer is necessary to be updated, a network user group ID corresponding to the priority information to be updated may then be determined, the corresponding relationship between the network user ID and network user group ID may be searched, network users in the network user group may be divided into groups again according to method described in block 202, network service priority and user group priority may be set according to method described in block 203, new grouping result and priority setting result may be stored according to method described in block 204.

It is necessary to update the priority information in the following scenes. If validity has been set for priority information in the priority buffer, when the priority information is expired, it is necessary to update the expired priority information. A priority updating instruction may also be received by the priority buffer, and then priority information specified in the instruction may be updated, or priority information corresponding to network user group ID specified in the instruction may be updated.

In the method embodiment, if it is necessary to update contents pulling strategy in the contents-pulling-strategy buffer, network user group ID corresponding to the contents pulling strategy to be pulled may then be determined. The network user group ID and corresponding priority information may be read from the priority buffer according to method described in block 205, the contents pulling strategy of network users in the network user group may be generated according to the priority information, and then, the network user group ID and the contents pulling strategy of network users in the network user group may be stored into the contents-pulling-strategy buffer correspondingly, according to method described in block 206.

It is necessary to update contents pulling strategy in the following scenes. If validity has been set for contents pulling strategy in the contents-pulling-strategy buffer, when the contents pulling strategy is expired, it is necessary to update the expired contents pulling strategy. A contents-pulling-strategy updating instruction may also be received by the contents-pulling-strategy buffer, the contents pulling strategy specified in the instruction may be updated, or the contents pulling strategy corresponding to the network user group ID specified in the instruction may be updated.

In the method embodiment, only the network service priority or only the user group priority of network users in each network user group may be set in block 203.

When setting the network service priority, network users may be enabled to obtain cared network services at first, and user experience may be improved.

When setting the user group priority, different contents pulling strategies may be adopted for different user groups, thus personal services may be provided for network users, and user experience may be improved.

A system embodiment corresponding to the above method embodiment will be provided in the following.

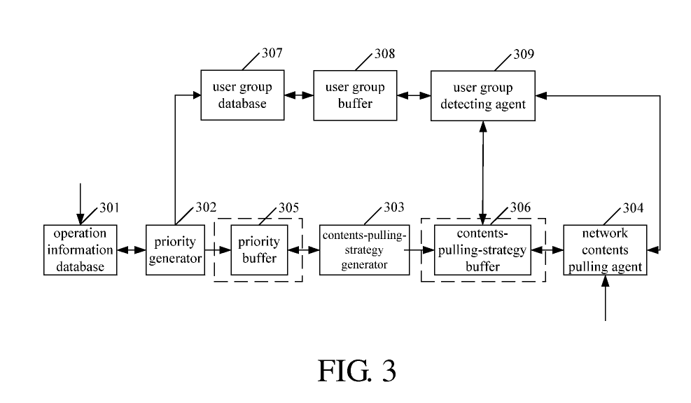

FIG. 3 is a diagram illustrating structure of a system for pulling network contents in accordance with a system embodiment of the present invention. As shown in FIG. 3, the system includes an operation information database 301, a priority generator 302, a contents-pulling-strategy generator 303 and a network contents pulling agent 304.

Operation information database 301 is configured to record operation information of network users.

Priority generator 302 is configured to set network service priority and/or user group priority for a network user according to the operation information in the operation information database 301.

Contents-pulling-strategy generator 303 is configured to generate and store a contents pulling strategy corresponding to the priority information in priority generator 302.

Network contents pulling agent 304 is configured to obtain contents pulling strategy corresponding to priority of a network user, when it is necessary to pull network contents for the network user, and is configured to pull network contents according to the contents pulling strategy.

The system may further include a priority buffer 305, a contents-pulling-strategy buffer 306, a user group database 307, a user group buffer 308 and a user group detecting agent 309.

And then, priority generator 302 is configured to divide network users into groups according to the operation information in operation information database 301, establish a corresponding relationship between network user ID and group ID, set network service priority and/or user group priority for network users in each group, store the corresponding relationship between the network user ID and group ID into user group database 307, send the set priority information and corresponding group ID to priority buffer 305, in which the priority information and corresponding group ID may be stored into the priority database at first, and then be buffered in priority buffer 305.

User group database 307 is configured to store the corresponding relationship between network user ID and group ID.

User group buffer 308 is configured to buffer the corresponding relationship in user group database 307.

Priority buffer 305 is configured to store a corresponding relationship between group ID and priority information of network users in the group.

Contents-pulling-strategy generator 303 is configured to read group ID and corresponding priority information from priority buffer 305, generate a corresponding contents pulling strategy according to the priority information, send the group ID and the contents pulling strategy to contents-pulling-strategy buffer 306. Or, the group ID and the contents pulling strategy may be stored into the contents-pulling-strategy database at first, and then be buffered in contents-pulling-strategy buffer 306.

Contents-pulling-strategy buffer 306 is configured to store the group ID and the contents pulling strategy of network users in the group correspondingly.

Network contents pulling agent 304 is configured to send a searching request carrying network user ID to user group detecting agent 309, according to a network contents pulling request of a network user, and pull network contents according to the contents pulling strategy returned by user group detecting agent 309.

User group detecting agent 309 is configured to search user group buffer 308 according to the network user ID carried in the searching request, after receiving the searching request sent by network contents pulling agent 304, obtain group ID corresponding to the network user ID, search contents-pulling-strategy buffer 306, and return the contents pulling strategy corresponding to the group ID to network contents pulling agent 304.

Priority buffer 305 may include a group information container, a network service priority container and a user group priority container.

The group information container is configured to store user group priority and network service priority of network users in the group corresponding to the group ID.

The user group priority container is configured to store user group type and user group priority of network users in the group corresponding to the group ID.

The network service priority container is configured to store network service type and network service priority of network users in the group corresponding to the group ID.

Priority buffer 305 is further configured to send a group ID corresponding to an updating instruction or expired priority, and a priority generating instruction to priority generator 302, after receiving the priority updating instruction or when the stored priority is expired, to set a result according to the priority sent by priority generator 302, store the group ID and the priority information of network users in the group correspondingly.

Correspondingly, priority generator 302 is further configured to divide network users, in a group identified with the received group ID, into groups once again, according to the operation information in operation information database 301 and after receiving the priority generating instruction, set network service priority and/or user group priority, store re-grouping result into user group database 307, and send another result set according to the priority to priority buffer 305.

Contents-pulling-strategy buffer 306 is further configured to send a group ID corresponding to an updating instruction or expired contents pulling strategy, and a contents-pulling-strategy generating instruction to contents-pulling-strategy generator 303, after receiving the contents-pulling-strategy generating instruction or when the stored contents pulling strategy is expired, store the group ID and the contents pulling strategy correspondingly, after receiving the contents pulling strategy returned by contents-pulling-strategy generator 303.

Correspondingly, contents-pulling-strategy generator 303 is further configured to read corresponding priority information according to received group ID form priority buffer 305, after receiving the contents-pulling-strategy generating instruction, generate corresponding contents pulling strategy according to the priority information, and send the contents pulling strategy to contents-pulling-strategy buffer 306.

Priority generator 302 is further configured to read operation information of network users from the operation information database periodically, set the network service priority and/or user group priority for network users according to the operation information.

Each constituted component in the system shown in FIG. 3 will be respectively described in the followings accompanying with embodiments.

Table 1 illustrates storage structure of operation information database 301. Based on Table 1, it can be seen that in operation information database 301, a user's action operation type and time for recording the action operation are both stored corresponding to the user ID. The action operation type refers to the operation information of the user.

TABLE 1

| field | name | meaning |
|---|---|---|
| userid varchar(20) | user ID | Recording the user ID |
| op_type number | Action operation | Identifying type of |
| | type | operations performed |
| | | by the user, such as |
| | | writing log, mapping, |
| | | listening to music, etc |
| op_time date | Recording time | May 21, 2008 |

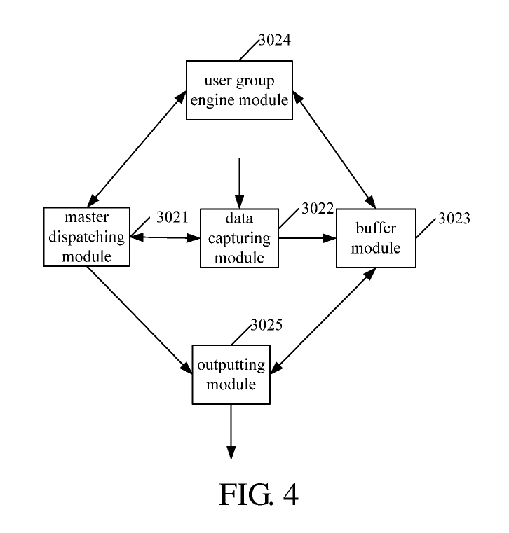

FIG. 4 is a diagram illustrating structure of a priority generator 302. As shown in FIG. 4, priority generator 302 includes a master dispatching module 3021, a data capturing module 3022, a buffer module 3023, a user group engine module 3024 and an outputting module 3025.

Master dispatching module 3021 is configured to dispatch data capturing module 3022 periodically, dispatch user group engine module 3024 after receiving a capturing completion instruction from data capturing module 3022, and dispatch outputting module 3025 after receiving a grouping completion instruction from user group engine module 3024.

Data capturing module 3022 is configured to capture network user ID and operation corresponding information from operation information database 301, after receiving a dispatching command from master dispatching module 3021, send the capturing completion instruction to master dispatching module 3021, after storing the network user ID and the operation information into buffer module 3023,

User group engine module 3024 is configured to read the network user ID and corresponding operation information from buffer module 3023, after receiving the dispatching command from master dispatching module 3021, divide network users into groups according to preset network service priority generating rule, user group priority generating rule and the operation information, set network service priority and user group priority of network users in each group, establish a corresponding relationship between network user ID and network user group ID, store the corresponding relationship between the network user ID and the network user group ID, as well as priority of network users in each group into buffer module 3023.

Outputting module 3025 is configured to extract the corresponding relationship between the network user ID and the network user group ID, as well as the priority of network users in each group from buffer module 3023, after receiving the dispatching command from master dispatching module 3021, and then store the extracted corresponding relationship and priority into priority buffer 305.

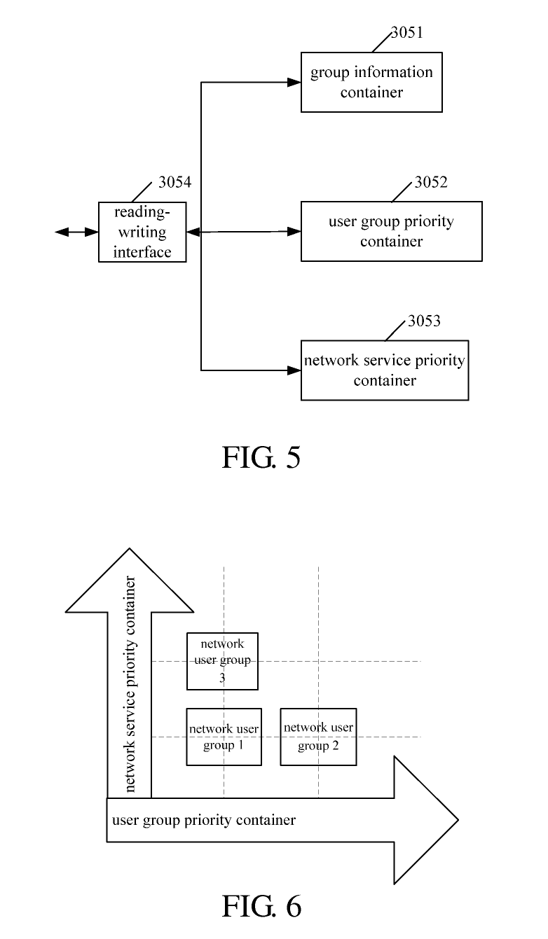

FIG. 5 is a diagram illustrating structure of a priority buffer 305. As shown in FIG. 5, priority buffer 305 includes a group information container 3051, a user group priority container 3052, a network service priority container 3053 and a reading-writing interface 3054.

Group information container 3051 is configured to store network service priority, user group priority of network users in the group corresponding to the network user group ID, and network user ID in the group. The network service priority and user group priority may be demonstrated with corresponding symbol variable.

User group priority container 3052 is configured to store user group type and user group priority of network users in the group corresponding to the network user group ID, in which the user group type and user group priority may be demonstrated with corresponding symbol variable.

Network service priority container 3053 is configured to store network service type and network service priority of network users in the group corresponding to the network user group ID, in which the network service type and network service priority may be demonstrated with corresponding symbol variable.

Reading-writing interface 3054 is configured to search group information container 3051, or user group priority container 3052, or network service priority container 3053, according to network user ID or network user group ID carried in a request, after receiving the request for reading group ID and corresponding priority information sent by contents-pulling-strategy generator 303, return priority information searched out to contents-pulling-strategy generator 303; to read user group priority or network service priority from user group priority container 3052 or network service priority container 3053; to store the corresponding relationship between network user ID and network user group ID, which comes from priority generator 302, into group information container 3051, or to store the user group priority of network users in each group into user group priority container 3052, or to store the network service priority of network users in each group into network service priority container 3053.

FIG. 6 is a schematic diagram illustrating storage structure of a user group priority container 3052 and a network service priority container 3053. As shown in FIG. 6, in a two-dimensional storage space, horizontal storage space is user group priority container 3052. Priority of network users in the group is higher when x-coordinate value is larger. Vertical storage space is network service priority container 3053. Priority of network service is higher when y-coordinate value is larger. Network user group ID is attached on the cross point of user group priority container 3052 and network service priority container 3053.

In FIG. 6, when comparing network user group 1 with network user group 2, the user group priority of network user group 1 is lower, however, the network service priority of them are the same. When comparing network user group 1 with network user group 3, the network service priority of network user group 1 is lower, however, the user group priority of them are the same.

When the network service priority and user group priority are stored with the storage structure illustrated in FIG. 6, each storage node in the two-dimensional storage space is initialized at first, and then the network service priority of the network user group is taken as y-coordinate, the user group priority of the network user group is taken as x-coordinate, and group ID of network users in the group is stored in a cross point of the x-coordinate and the y-coordinate.

When it is necessary to adjust priority of a network user group, it only needs to adjust node location where the network user group ID located. When it is necessary to adjust user group priority of a network user group, y-coordinate of the network user group ID is kept unchanged, meanwhile x-coordinate of the network user group ID may be changed to demonstrate x-coordinate of adjusted user group priority. When it is necessary to adjust network service priority of a network user group, x-coordinate of the network user group ID is kept unchanged, meanwhile y-coordinate of the network user group ID is changed to demonstrate y-coordinate of adjusted network service priority.

When it is necessary to search for priority of a network user group, it only needs to search for node location where the network user group ID located. When it is necessary to search for user group priority of a network user group, x-coordinate value of the network user group ID may be extracted. When it is necessary to search for network service priority of a network user group, y-coordinate value of the network user group ID may be extracted.

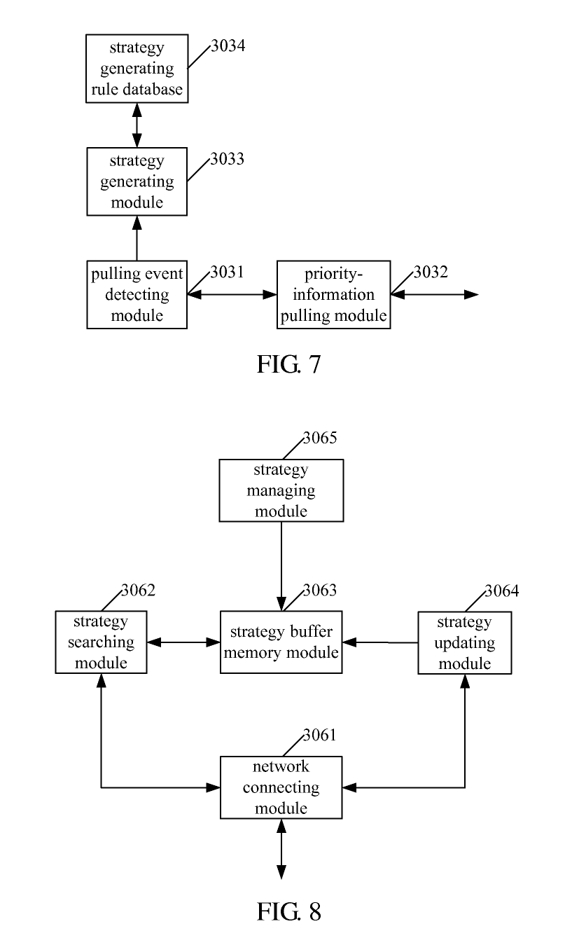

FIG. 7 is a diagram illustrating structure of a contents-pulling-strategy generator 303. As shown in FIG. 7, contents-pulling-strategy generator 303 includes a pulling event detecting module 3031, a priority-information pulling module 3032, a strategy generating module 3033 and a strategy generating rule database 3034.

Pulling event detecting module 3031 is configured to send a pulling instruction to priority-information pulling module 3032, after detecting an updating strategy instruction or a strategy generating instruction, or send the pulling instruction to priority-information pulling module 3032 periodically; and is configured to send a generating instruction to strategy generating module 3033, after receiving a pulling completion instruction from priority-information pulling module 3032.

Priority-information pulling module 3032 is configured to send a request for reading group ID and corresponding priority information to priority buffer 305, after receiving the pulling instruction, and send the pulling completion instruction to pulling event detecting module 3031, after receiving the network user group ID, network service priority and user group priority of network users in the group returned by priority buffer 305.

Strategy generating module 3033 is configured to generate a contents pulling strategy for network users in the group, according to the network service priority and user group priority both pulled by priority-information pulling module 3032, and according to strategy generating rule in strategy generating rule database 3034, after receiving the generating instruction.

Strategy generating rule database 3034 is configured to store generating rules of the contents pulling strategy.

The generating rule in strategy generating rule database 3034 may be preset by ISP, e.g., as to a payment network user group network users therein write log frequently (user priority is higher, and compared with other network services, the network service of writing log possesses a higher priority). An IP address of a server with higher network bandwidth and abundant log resources may be designated as IP address of pulling server for network users in the group. Besides, packet promotion information related with writing log may be designated as network contents to be pulled.

FIG. 8 is a diagram illustrating structure of a contents-pulling-strategy buffer 306. As shown in FIG. 8, contents-pulling-strategy buffer 306 includes a network connecting module 3061, a strategy searching module 3062, a strategy buffer memory module 3063, a strategy updating module 3064 and a strategy managing module 3065.

Network connecting module 3061 is configured to send a searching instruction carrying a group ID to strategy searching module 3062 according to the group ID carried in a searching request, after receiving the searching request from user group detecting agent 309, output a contents pulling strategy or searching failure message returned by strategy searching module 3062 to user group detecting agent 309, and send an updating instruction to strategy updating module 3064, after receiving an updating request from strategy searching module 3062.

Strategy searching module 3062 is configured to search for a contents pulling strategy corresponding to the group ID in strategy buffer memory module 3063, after receiving the searching instruction carrying the group ID. If corresponding contents pulling strategy has been searched out, strategy searching module 3062 is further configured to return the contents pulling strategy to network connecting module 3061, otherwise, strategy searching module 3062 is further configured to return a searching failure message and an updating request.

Strategy buffer memory module 3063 is configured to store contents pulling strategy for network users in the group corresponding to the network user group ID.

Strategy updating module 3064 is configured to update the contents pulling strategy in strategy buffer memory module 3063, after receiving the updating instruction from strategy managing module 3065 or network connecting module 3061, and return an updating success message or updating failure message to network connecting module 3061.

Strategy managing module 3065 is configured to scan the contents pulling strategy in strategy buffer memory module 3063 periodically, and send an updating instruction to strategy updating module 3064 when finding an expired strategy.

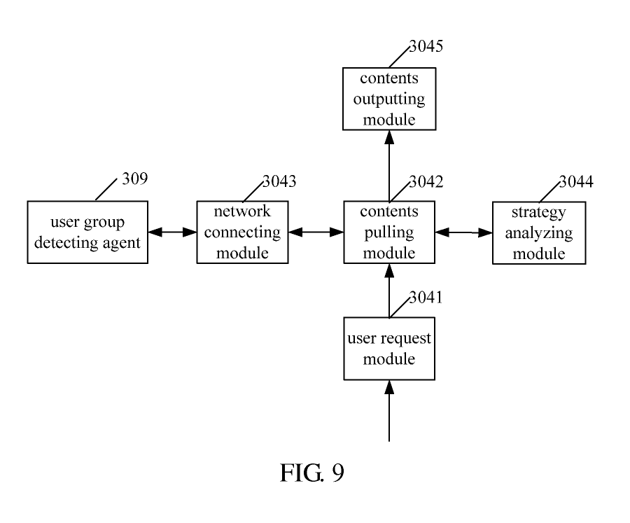

FIG. 9 is a diagram illustrating structure of a network contents pulling agent 304. As shown in FIG. 9, network contents pulling agent 304 includes a user request module 3041, a contents pulling module 3042, a network connecting module 3043, a strategy analyzing module 3044 and a contents outputting module 3045.

After receiving a connecting request from user request module 3041, contents pulling module 3042 is configured to call network connecting module 3043 to establish a network connection with user group detecting agent 309, send a searching request carrying a network user ID to user group detecting agent 309 through network connecting module 3043, output a contents pulling strategy to strategy analyzing module 3044, after receiving the contents pulling strategy returned by user group detecting agent 309, pull network contents according to a pulling rule analyzed by strategy analyzing module 3044. Contents outputting module 3045 is configured to output the pulled network contents.

User request module 3041 is configured to send a connecting request to contents pulling module 3042, according to a user request.

Network connecting module 3043 is configured to establish a network connection between contents pulling module 3042 and user group detecting agent 309, after receiving a call command from contents pulling module 3042, and forward the searching request carrying the network user ID to user group detecting agent 309.

Strategy analyzing module 3044 is configured to analyze received contents pulling strategy to obtain a pulling rule, and send the pulling rule to contents pulling module 3042.

Contents outputting module 3045 is configured to output network contents pulled by contents pulling module 3042.

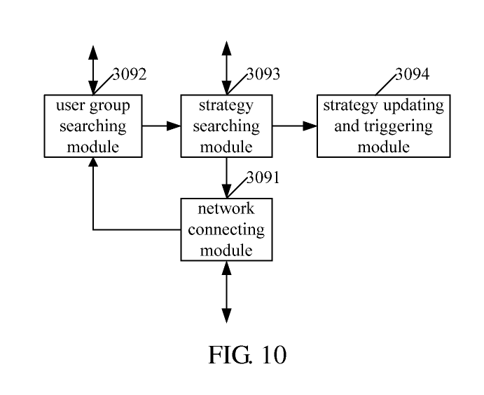

FIG. 10 is a diagram illustrating structure of a user group detecting agent 309. As shown in FIG. 10, user group detecting agent 309 includes a network connecting module 3091, a user group searching module 3092, a strategy searching module 3093, a strategy updating and triggering module 3094.

Network connecting module 3091 is configured to send a network user ID carried in a searching request sent by network contents pulling agent 304 to user group searching module 3092, and forward a contents pulling strategy returned by strategy searching module 3093 to network contents pulling agent 304.

User group searching module 3092 is configured to search for user group buffer 308 according to the network user ID, and send a group ID corresponding to the network user ID in user group buffer 308 to strategy searching module 3093.

Strategy searching module 3093 is configured to search for a contents pulling strategy corresponding to the group ID in contents-pulling-strategy buffer 306, according to the group ID returned by user group searching module 3092, return the contents pulling strategy searched out to network contents pulling agent 304 through network connecting module 3091. If the contents pulling strategy corresponding to the group ID hasn't been searched out, strategy searching module 3093 is further configured to send an updating request with the group ID to strategy updating and triggering module 3094.

Strategy updating and triggering module 3094 is configured to send the updating request with the group ID to contents-pulling-strategy buffer 306.

Operation information database 301, priority generator 302, contents-pulling-strategy generator 303, priority buffer 305, contents-pulling-strategy buffer 306, user group database 307, user group buffer 308 and user group detecting agent 309 are run in a server of the ISP. Network contents pulling agent 304 is run in a network browser of client.

From the above technical solution, it can be seen that, the network service priority and/or user group priority are set for a network user according to operation information of the network user, a pulling strategy corresponding to the priority is generated, and network contents are pulled for the network user according to the pulling strategy. The following advantages may be achieved.

From the standpoint of Internet users, since contents pulling strategy is based on former operation information of the network user, degree of attention paid by the network user to each kind of network services may be demonstrated. Thus, when adopting corresponding contents pulling strategy for different network users, a network user may be enabled to obtain cared network services at first, and user experience may be improved. If a network service cared by a network user may be allocated with more network resources, such as higher network bandwidth, user experience may be further improved.

From the standpoint of the ISP, since contents pulling strategy may be determined according to strategy of the ISP, the ISP may differentiate network users according to user group priority, or network service priority, establish corresponding contents pulling strategy for a given network user, so as to facilitate deploying services, adjusting services, providing personal services, e.g., personal network contents pushing, etc, for network users.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A method for pulling network contents, comprising:
recording operation information of a network user;
setting at least one of network service priority and user group priority for the network user according to the operation information of the network user;
generating and storing a contents pulling strategy corresponding to at least one of the network service priority and the user group priority;
when it is necessary to pull network contents for the network user, obtaining the contents pulling strategy corresponding to at least one of the network service priority and the user group priority of the network user, and
pulling the network contents according to the contents pulling strategy.

2. The method according to claim 1, wherein setting at least one of the network service priority and the user group priority for the network user according to the operation information of the network user comprises:
dividing network users into groups according to operation information of the network users;
establishing a corresponding relationship between network user Identity (ID) and group ID;
setting at least one of the network service priority and the user group priority for network users in each group;
storing the corresponding relationship between the network user ID and the group ID into a user group buffer; and
storing set priority information and the group ID into a priority buffer correspondingly.

3. The method according to claim 2, wherein generating the contents pulling strategy corresponding to at least one of the network service priority and the user group priority comprises:
reading the group ID and priority information corresponding to the group ID from the priority buffer;
generating the contents pulling strategy according to the priority information;
storing the group ID and the contents pulling strategy to a contents-pulling-strategy buffer correspondingly;
wherein obtaining the contents pulling strategy corresponding to at least one of the network service priority and the user group priority of the network user comprises:
searching the user group buffer to obtain the group ID of a network user group to which the network user belongs, and
reading the contents pulling strategy of the network user from the contents-pulling-strategy buffer according to the group ID.

4. The method according to claim 2, wherein storing the set priority information and the group ID into the priority buffer correspondingly comprises:
storing a corresponding relationship between the group ID and the user group priority, the network service priority to the priority buffer;
storing a corresponding relationship between the group ID and user group type, the user group priority to the priority buffer; and
storing a corresponding relationship between the group ID and network service type, the network service priority to the priority buffer.

5. The method according to claim 3, further comprising:
when it is necessary to update the priority information in the priority buffer, determining the network user corresponding to the priority information to be updated, setting at least one of the network service priority, and the user group priority of the network user according to the operation information of the network user;
when it is necessary to update the contents pulling strategy in the contents-pulling-strategy buffer, determining the group ID corresponding to the contents pulling strategy to be updated, reading the priority information corresponding to the group ID from the priority buffer, generating a contents pulling strategy once again according to read priority information, and updating the contents-pulling-strategy buffer according to newly generated contents pulling strategy.

6. The method according to claim 2, wherein recording the operation information of the network user comprises:
storing a corresponding relationship between the operation information of the network user and the network user ID to an operation information database;
reading the network user ID and the operation information corresponding to the network user ID from the operation information database periodically, and storing read network user ID and the operation information corresponding to the network user ID to a buffer; and
setting at least one of the network service priority and the user group priority of the network user according to the operation information of the network user in the buffer.

7. The method according to claim 1, wherein pulling the network contents according to the contents pulling strategy comprises:
generating a pulling rule according to one or at least two contents pulling strategies, and pulling the network contents according to the pulling rule.

8. A system for pulling network contents, wherein the system comprises an operation information database, a priority generator, a contents-pulling-strategy generator and a network contents pulling agent,
the operation information database is configured to record operation information of a network user;
the priority generator is configured to set at least one of network service priority and user group priority for the network user according to the operation information in the operation information database;
the contents-pulling-strategy generator is configured to generate and store a contents pulling strategy corresponding to at least one of the network service priority and the user group priority in the priority generator;
the network contents pulling agent is configured to obtain the contents pulling strategy corresponding to at least one of the network service priority and the user group priority of the network user, when it is necessary to pull network contents for the network user, and pull the network contents according to the contents pulling strategy.

9. The system according to claim 8, wherein the system further comprises a priority buffer and a user group buffer,
the priority generator is configured to divide network users into groups according to operation information in the operation information database, establish a corresponding relationship between network user Identity (ID) and group ID, set at least one of the network service priority and the user group priority for network users in each group, store the corresponding relationship between the network user ID and the group ID to the user group buffer, and send a corresponding relationship between priority information and the group ID to the priority buffer;
the user group buffer is configured to buffer the corresponding relationship between the network user ID and the group ID;
the priority buffer is configured to store the group ID and the priority information of network users in the group correspondingly;
the contents-pulling-strategy generator is configured to read the group ID and corresponding priority information from the priority buffer, and generate the corresponding contents pulling strategy according to the priority information.

10. The system according to claim 9, wherein the system further comprises a user group detecting agent and a contents-pulling-strategy buffer,
the user group detecting agent is configured to search the user group buffer according to a network user ID carried in a searching request, after receiving the searching request sent by the network contents pulling agent, obtain the group ID corresponding to the network user ID, search the contents-pulling-strategy buffer, return the contents pulling strategy corresponding to the group ID to the network contents pulling agent;
the contents-pulling-strategy generator is further configured to send generated contents pulling strategy and the group ID corresponding to the generated contents pulling strategy to the contents-pulling-strategy buffer;
the contents-pulling-strategy buffer is configured to store a corresponding relationship between the group ID and the contents pulling strategy of network users in the group;
the network contents pulling agent is further configured to send a searching request to the user group detecting agent, when it is necessary to pull the network contents for the network user, and pull the network contents according to the contents pulling strategy returned by the user group detecting agent.

11. The system according to claim 10, wherein the priority buffer comprises a group information container, a network service priority container and a user group priority container,
the group information container is configured to store a corresponding relationship between the group ID and the user group priority, the network service priority;
the network service priority container is configured to store a corresponding relationship between the group ID and user group type, the user group priority;
the user group priority container is configured to store a corresponding relationship between the group ID and network service type, the network service priority.

12. The system according to claim 10, wherein
the priority buffer is further configured to send a group ID corresponding to a priority updating instruction or expired priority information, and a priority generating instruction to the priority generator, when receiving the priority updating instruction or when stored priority information is expired, set a result according to priority returned by the priority generator, update the priority information corresponding to the group ID in the priority buffer;
the priority generator is further configured to divide network users in a group identified with the received group ID once again, according to the operation information in the operation information database, after receiving the priority generating instruction, set at least one of the network service priority and the user group priority, store new group result to the user group buffer, and send the result set according to the priority to the priority buffer.

13. The system according to claim 10, wherein
the contents-pulling-strategy buffer is further configured to send a group ID corresponding to a contents-pulling-strategy updating instruction or expired contents pulling strategy, and a contents-pulling-strategy generating instruction to the contents-pulling-strategy generator, after receiving the contents-pulling-strategy updating instruction or when the stored contents pulling strategy is expired, store the group ID and the contents pulling strategy correspondingly, after receiving the contents pulling strategy returned by the contents-pulling-strategy generator;
the contents-pulling-strategy generator is further configured to read corresponding priority information from the priority buffer according to the received group ID, after receiving the contents-pulling-strategy generating instruction, generate the corresponding contents pulling strategy according to the priority information, and send the contents pulling strategy to the contents-pulling-strategy buffer.

14. The system according to claim 8, wherein the priority generator is configured to read the operation information from the operation information database periodically, set at least one of the network service priority and the user group priority for the network user according to read operation information.

15. The system according to claim 9, wherein the priority generator comprises a master dispatching module, a data capturing module, a buffer module, a user group engine module and an outputting module;
the master dispatching module is configured to dispatch the data capturing module periodically, dispatch the user group engine module after receiving a capturing completion instruction from the data capturing module, and dispatch the outputting module after receiving a grouping completion instruction from the user group engine module;
the data capturing module is configured to capture the network user ID and the operation information from the operation information database, after receiving a dispatching command from the master dispatching module, and send the capturing completion instruction to the master dispatching module, after storing the network user ID and the operation information to the buffer module;
the user group engine module is configured to read the network user ID and the operation information from the buffer module, after receiving the dispatching command from the master dispatching module, divide the network users into groups according to preset network service priority generating rule, preset user group priority generating rule and the operation information, set the network service priority and the user group priority for the network users in each group, establish the corresponding relationship between the network user ID and the group ID, store the corresponding relationship between the network user ID and the group ID, and the priority of the network users in each group to the buffer module;
the outputting module is configured to extract the corresponding relationship between the network user ID and the group ID, the priority of the network users in each group from the buffer module and store to the priority buffer, after receiving the dispatching command from the master dispatching module.

16. The system according to claim 9, wherein the contents-pulling-strategy generator comprises a pulling event detecting module, a priority-information pulling module, a strategy generating module and a strategy generating rule database,
the pulling event detecting module is configured to send a pulling instruction to the priority-information pulling module, after detecting an updating strategy instruction or a strategy generating instruction, or send the pulling instruction to the priority-information pulling module periodically; send a generating instruction to the strategy generating module, after receiving a pulling completion instruction from the priority-information pulling module;
the priority-information pulling module is configured to send a request for reading the group ID and corresponding priority information to the priority buffer, after receiving the pulling instruction, and send the pulling completion instruction to the pulling event detecting module, after receiving the group ID, the network service priority and the user group priority of the network users in the group returned by the priority buffer;
the strategy generating module is configured to generate the contents pulling strategy for the network users in the group, according to a strategy generating rule in the strategy generating rule database, the network service priority and the user group priority both pulled by the priority-information pulling module, after receiving the generating instruction;
the strategy generating rule database is configured to store the generating rule of the contents pulling strategy.

17. The system according to claim 10, wherein the contents-pulling-strategy buffer comprises a network connecting module, a strategy searching module, a strategy buffer memory module, a strategy updating module and a strategy managing module;
the network connecting module is configured to send a searching instruction carrying the group ID to the strategy searching module, according to the group ID carried in a searching request, after receiving the searching request from the user group detecting agent, output the contents pulling strategy or a searching failure message returned by the strategy searching module to the user group detecting agent; send an updating instruction to the strategy updating module, after receiving an updating request from the strategy searching module;
the strategy searching module is configured to search for the contents pulling strategy corresponding to the group ID in the strategy buffer memory module, after receiving the searching instruction carrying the group ID, if corresponding contents pulling strategy has been searched out, return the contents pulling strategy to the network connecting module; otherwise, return the searching failure message and the updating request to the network connecting module;
the strategy buffer memory module is configured to store the contents pulling strategy for the network users in the group corresponding to the group ID;
the strategy updating module is configured to update the contents pulling strategy stored in the strategy buffer memory module, after receiving the updating instruction from the strategy managing module or the network connecting module, return an updating success message or the updating failure message to the network connecting module;
the strategy managing module is configured to scan the contents pulling strategy in the strategy buffer memory module periodically, and send the updating instruction to the strategy updating module when detecting the contents pulling strategy is expired.

18. The system according to claim 8, wherein the network contents pulling agent comprises a user request module, a contents pulling module, a network connecting module, a strategy analyzing module and a contents outputting module;
the contents pulling module is configured to call the network connecting module to establish a network connection with the user group detecting agent, after receiving a connecting request from the user request module, send the searching request carrying the network user ID to the user group detecting agent through the network connecting module, send the contents pulling strategy to the strategy analyzing module, after receiving the contents pulling strategy returned by the user group detecting agent, pull the network contents according to a pulling rule analyzed by the strategy analyzing module, and the contents outputting module is configured to output the pulled network contents;
the user request module is configured to send the connecting request to the contents pulling module according to a user request;
the network connecting module is configured to establish the network connection between the contents pulling module and the user group detecting agent, after receiving a calling command from the contents pulling module, and forward the searching request carrying the network user ID to the user group detecting agent;
the strategy analyzing module is configured to analyze the pulling rule according to the received contents pulling strategy, and send the analyzed pulling rule to the contents pulling module;
the contents outputting module is configured to output the network contents pulled by the contents pulling module.

19. The system according to claim 10, wherein the user group detecting agent comprises a network connecting module, a user group searching module, a strategy searching module, a strategy updating and triggering module;
the network connecting module is configured to send the network user ID carried in the searching request sent by the network contents pulling agent to the user group searching module, forward the contents pulling strategy returned by the strategy searching module to the network contents pulling agent;
the user group searching module is configured to search the user group buffer according to the network user ID, send the group ID corresponding to the network user ID in the user group buffer to the strategy searching module;
the strategy searching module is configured to search for the contents pulling strategy corresponding to the group ID in the contents-pulling-strategy buffer, according to the group ID returned by the user group searching module, return the contents pulling strategy searched out to the network contents pulling agent through the network connecting module, if the contents pulling strategy corresponding to the group ID hasn't been searched out, send the updating request carrying the group ID to the strategy updating and triggering module;
the strategy updating and triggering module is configured to send the updating request carrying the group ID to the contents-pulling-strategy buffer.
